(19) United States
(12) Patent Application Publication
(10) Pub. No.: US 2019/0360782 A1
(43) Pub. Date: Nov. 28, 2019

(54) System for Protecting and Alerting Individuals in Indoor Environments of Active Shooter Incidents

(71) Applicant: Gary Richard Blackburn, Coconut Creek, FL (US)

(72) Inventor: Gary Richard Blackburn, Coconut Creek, FL (US)

(21) Appl. No.: 16/419,816

(22) Filed: May 22, 2019

Related U.S. Application Data
(60) Provisional application No. 62/674,722, filed on May 22, 2018.

(51) Int. Cl. F41H 5/24; F41H 11/00; G08B 5/36; G08B 21/02

(52) U.S. Cl. CPC F41H 5/24; G08B 21/02; G08B 5/36; F41H 11/00

(57) ABSTRACT

A system for protecting and alerting individuals in indoor environments of active shooter incidents includes a foldable shield wall, a bulletproof door panel, a foot bolt, an early warning blue light system (EWBLS), and at least one key fob. The foldable shield wall, the bulletproof door panel, and the foot bolt are mounted adjacent to each other. The foldable shield wall is mounted to a structural wall of a room, wherein the room is within a building, so that the foldable shield wall functions as a barrier between the victims and active shooter. The bulletproof door panel is mounted onto a main entry door of the room. The foot bolt is mounted onto the main entry door. Both the door panel and the foot bolt reinforce the existing entry door to withstand gunfire and force entry. The at least key fob is communicably coupled with the EWBLS.

The current application claims a priority to the U.S. Provisional Patent application Ser. No. 62/674,722 filed on May 22, 2018.

### FIELD OF THE INVENTION

The present invention relates generally to a defense system that protects individuals from firearm. More specifically, the present invention is a system for protecting and alerting individuals in indoor environments during active shooter incidents.

### BACKGROUND OF THE INVENTION

In present society, there has been a growing trend of active shooter incidents, in which at least one individual with a firearm wreaks havoc on an unsuspecting group of individuals that are within a closed or confined area or space. These active shooter incidents have occurred frequently in classrooms, offices, and other similar environments in which there are no active defense systems in place to address the surprising and abrupt nature of active shooter incidents. The only current types of deterrents for these individuals in these environments are usually limited to metal detectors at entrances, and sometimes a security personal. The only current types of defense are locking themselves in classrooms, offices or closets. But the walls and doors of most classrooms and offices are not made to withstand the sheer force and impact of bullets fired from an assault rifle. For instance, the current means of defense systems cannot handle a person wielding a high-powered assault rifle. Often, they may activate the facility fire alarm system to draw individuals out into the line of fire in hallways. Also, the fire alarm sirens often drown out the warnings and/or instructions from public address speakers.

Because of the politics surrounding availability of access to firearms, there has been stagnation in addressing how to best prevent or reduce to frequency of active shooter incidents. Others could argue that simply upgrading the walls and doors of classrooms would act as deterrence against bullets from firearms; however, this would be a nearly infeasible upgrade to overhaul in all schools and office buildings. While the debate surrounding the availability of access to firearms is highly heated on both sides of the debate, there is a need for a practical and sensible upgrade to defense systems currently in place in classrooms, offices, and the like.

It is the objective of the present invention to provide users with a system for protecting and alerting individuals in indoor environments during an active shooter threat. The present invention intends to provide users with a modular wall apparatus that can be deployed as a shield when an active shooter incident occurs. The present invention intends to provide users with an upgraded protective panel to existing entry doors commonly found in classrooms, offices, and the like. The present invention intends to provide users with an early warning system that can be easily implemented with existing alarm systems such as fire alarm systems.

### SUMMARY OF THE INVENTION

The present invention is a system for protecting and alerting individuals in indoor environments of active shooter threats. The apparatus of the present invention contains a wall apparatus, a door apparatus, and an early warning system. The wall apparatus contains a multitude of walls that are connected together at the sides by hinges so that the wall apparatus can be contracted, expanded, and pivoted to protect inhabitants from an active shooter. The wall apparatus contains caster wheels at bottom to make movement of the wall apparatus easier. The wall apparatus is made of a plurality of bullet-proof materials and the like. The door apparatus contains a plurality of bullet-proof materials and the like, similar to the wall apparatus. The door apparatus contains a foot bolt to prevent forceful entry of an active shooter into a classroom, office, or similar. The present invention contains an enhancement on currently existing alarm systems in classrooms, offices, and the like that includes blue light used as a visible alert to the presence of a threat and the ability for a public address loudspeaker to override alarm sirens when messages are needed to let users know if there is an active shooter, instructions on what to do, and other useful information.

### BRIEF DESCRIPTION OF THE DRAWINGS

FIG. 1 is a schematic diagram of the present invention.

FIG. 2 is a perspective view of the foldable shield wall of the present invention shown with the cross-sectional view of the structural wall.

FIG. 3 is a bottom perspective view of the foldable shield wall of the present invention.

FIG. 4 is a top perspective view of the foldable shield wall of the present invention.

FIG. 5 is a perspective view of the bulletproof door panel and the foot bolt of the present invention shown with the main entry door.

FIG. 6 is a perspective view of the foot bolt of the present invention

FIG. 7 is a schematic view the early warning blue light system with the related communicably coupled subcomponents.

### DETAIL DESCRIPTIONS OF THE INVENTION

All illustrations of the drawings are for the purpose of describing selected versions of the present invention and are not intended to limit the scope of the present invention.

The present invention is a system for protecting and alerting individuals in indoor environments of active shooter incidents or threats. The present invention can be of any shape, size, material, features, type or kind, orientation, location, quantity, components, and arrangements of components that would allow the present invention to fulfill the objectives and intents of the present invention. The present invention preferably utilized with a building 20 with at least one room 21 that includes a main entry door 23.

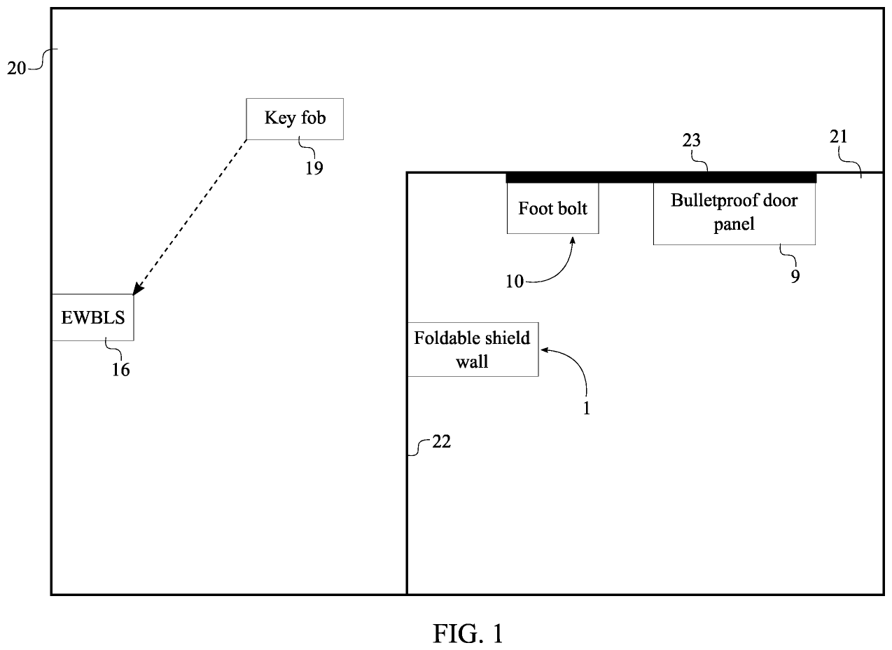

The present invention comprises a foldable shield wall 1, a bulletproof door panel 9, a foot bolt 10, an early warning blue light system (EWBLS) 16, and at least one key fob 19 as shown in FIG. 1. In reference to the general configuration of the present invention, the foldable shield wall 1, the bulletproof door panel 9, and the foot bolt 10 are mounted adjacent to each other so that each component can individual function with respect to each other. More specifically, the foldable shield wall 1 is mounted to a structural wall 22 of the room 21 and functions as a barrier between a victim and an active shooter. The bulletproof door panel 9 is mounted onto the main entry door 23 of the room 21 so that the main entry door 23 can be reinforced to withstand gunfire or force entry. The foot bolt 10 that functions as a quick release locking mechanism is mounted onto the main entry door 23. As a result, the main entry door 23 can be quickly locked from the inside of the room 21 in addition to the existing door lock that may or may not need a key. The at least key fob 19 is communicably coupled with the EWBLS 16. In the event of an emergency, the at least one key fob 19 can remotely activate the EWBLS 16 to indicate the state of emergency.

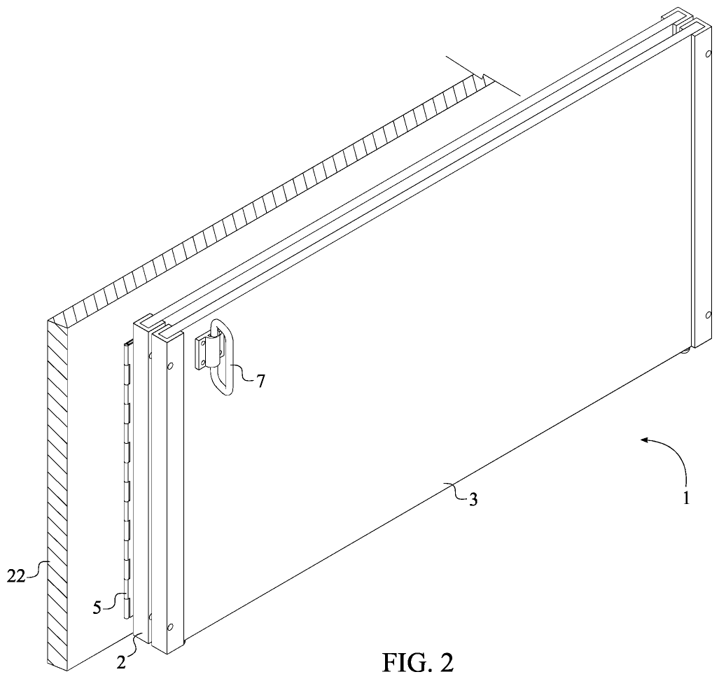

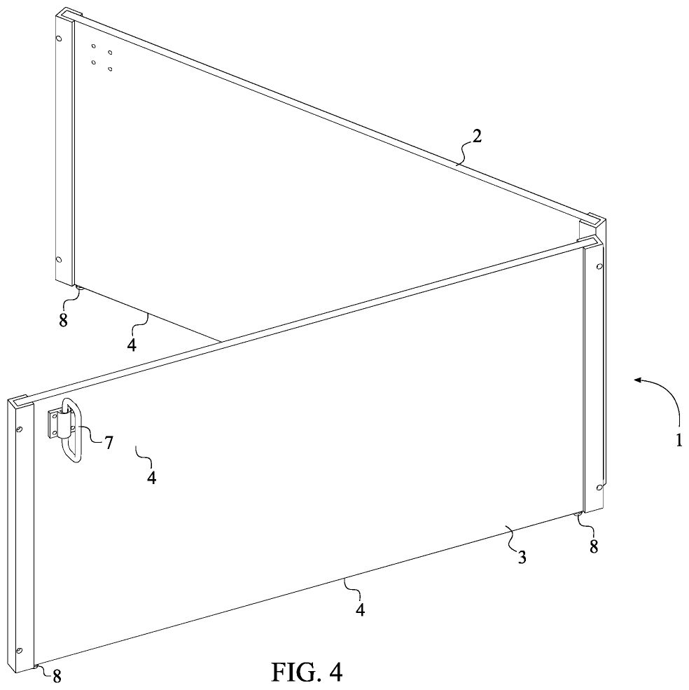

In reference to FIG. 2-4, the foldable shield wall 1 comprises a first bulletproof wall 2, a second bulletproof wall 3, a wall attachment 5, a connector hinge 6, and a handle 7. The foldable shield wall 1 can be made as any shape, size, and material that would allow the present invention to fulfill the objectives and intents of the present invention. However, it is preferred that the first bulletproof wall 2 and the second bulletproof wall 3 made of an anti-ballistic material that contains a high-density polyethylene sheet. The first bulletproof wall 2 and the second bulletproof wall 3 are hingedly mounted to each other through the connector hinge 6. The first bulletproof wall 2 and the second bulletproof wall 3 are preferably made into identical shapes in order to provide an aesthetically pleasing look and ease the operation of the foldable shield wall 1. The wall attachment 5 is terminally mounted to the first bulletproof wall 2, opposite of the connector hinge 6 so that the foldable shield wall 1 can be folded and placed against the structural wall 22 when not necessary. More specifically, the wall attachment 5 is mounted in between the structural wall 22 and the first bulletproof wall 2 thus enabling the operation of the foldable shield wall 1. The handle 7, preferably made of steel and polished zinc finish, provides a gripping body for an individual to maneuver the foldable shield wall 1. The handle 7 is foldably and terminally mounted to the second bulletproof wall 3, opposite of the connector hinge 6.

In a preferred embodiment of the first bulletproof wall 2 and the second bulletproof wall 3 each comprises a pair of end-trims that made of aluminum C-Channel. The pair of end-trims is mounted onto the opposite ends of the first bulletproof wall 2 and the second bulletproof wall 3 with self-tapping Philip head metal screws. Optionally, the first bulletproof wall 2 and the second bulletproof wall 3 may comprise a bottom trim that perpendicularly positioned to the pair of end-trims and connected to a bottom edge 4 of the first bulletproof wall 2 and the second bulletproof wall 3. The connector hinge 6 is a piano hinge that extends from a top edge of the first bulletproof wall 2 and the second bulletproof wall 3 to the bottom edge 4. As a result, the piano hinge is able to equally distribute the weight of the second bulletproof wall 3 to the first bulletproof wall 2. Similarly, another piano hinge is utilized as the wall connector so that the first bulletproof wall 2 and the second bulletproof wall 3 can be moved back and forth without compromising the structural integrity between the structural wall 22 and the foldable shield wall 1. The both piano hinges are attached to the side faces of the first bulletproof wall 2 and he second bulletproof wall 3 with self-tapping metal Phillip head screws.

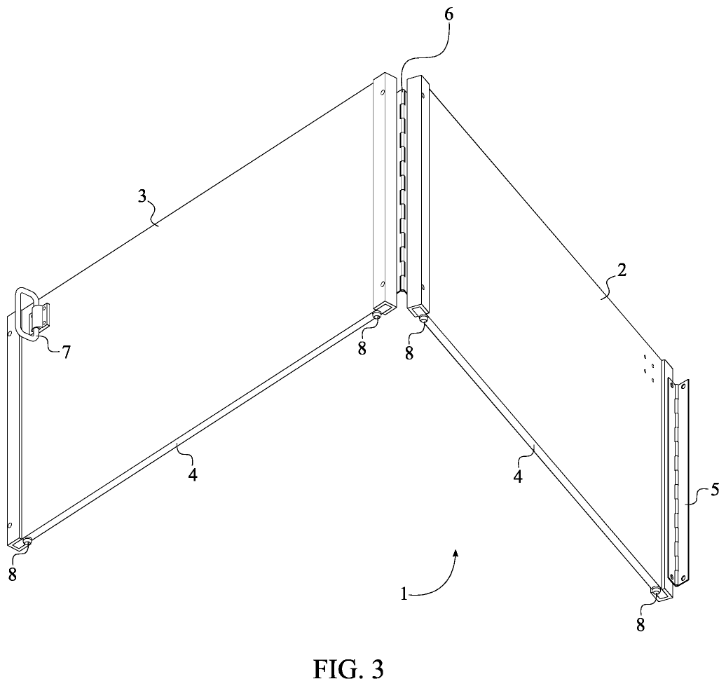

The present invention further comprises a plurality of caster wheels 8 as shown in FIG. 3. More specifically, the plurality of caster wheels 8 is equally distributed and mounted to the bottom edge 4 of the first bulletproof wall 2 and the second bulletproof wall 3. Resultantly, the plurality of caster wheels 8 ease the movement of the first bulletproof wall 2 and the second bulletproof wall 3 along the ground/floor surface minimizing friction. The plurality of caster wheels 8 is preferably made of carbon steel, steel, or combination of both to improve the reliability.

The foldable shield wall 1 is preferably utilized within a ground floor of the building 20 to safely maximize the coverage area. Optionally, when the present invention is utilized within upper floors of the building 20, the foldable shield wall 1 can be interchanged with at least one bulletproof wall panel that is directly mounted to a hallway wall of the building 20 from the inside of the the room 21. As a result, the at least one bulletproof wall panel can be hidden from an active shooter thus resembling as standard hallway wall from the point of view of the hallway. However, it is understood that the foldable shield wall 1 and the at least one bulletproof wall panel can also function together as a combine system.

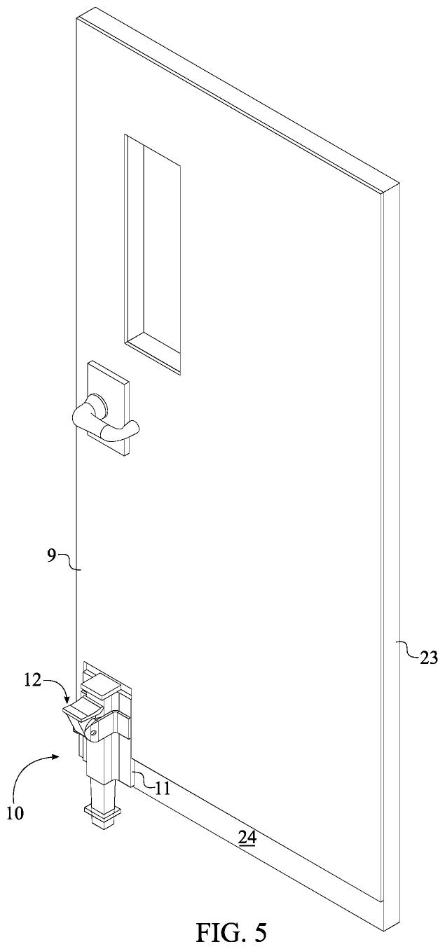

In reference to FIG. 5, the bulletproof door panel 9 is mounted onto an inside panel 24 of the main entry door 23. The bulletproof door panel 9 is preferably made of anti-ballistic material and can contain a plurality of cut-outs that matches the size and shape of the window and the handle 7 commonly found on the existing doors. The bulletproof door panel 9 is mounted with adhesive and the appropriate fasteners at the sides and the center of the door depending on the material of the door. Optionally, a secondary panel made of a corkboard material and of size similar to the bulletproof door panel 9 can be attached onto the bulletproof door panel 9 with adhesive thus concealing the appearance of the bulletproof door panel 9.

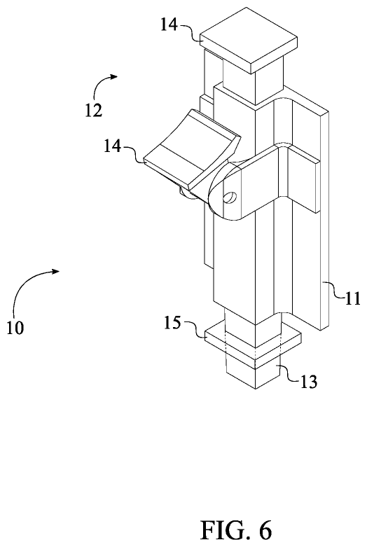

In reference to FIG. 5-6, the foot bolt 10 comprises a housing 11 and a bolt assembly 12, wherein the bolt assembly 12 is mechanically coupled within the housing 11. As a result, the bolt assembly 12 is able to easily move in between a locked position and an unlocked position. It is preferred that the foot bolt 10 be located at the lower inside corner, opposite from the door hinge side of door. The foot bolt 10 requires a deep hole in the ground/floor surface of the room 21 directly beneath to securely maintain the locked position.

More specifically, the bolt assembly 12 comprises a deadbolt 13, an operating mechanism 14, and a strike plate 15. The deadbolt 13 is slidably engaged within the housing 11 as the operating mechanism 14 is integrated into the deadbolt 13 and the housing 11. The operating mechanism 14 is preferably a locking paddle and a release paddle system that moves the blot assembly between the locked position and the unlocked position, respectively. The strike plate 15 is mounted adjacent to the deadbolt 13 and concentrically aligned with the deadbolt 13 and the deep hole. Furthermore, the width of deadbolt 13 is slightly smaller than the width of the strike plate 15 opening so that the deadbolt 13 can slide in and out of the deep hole.

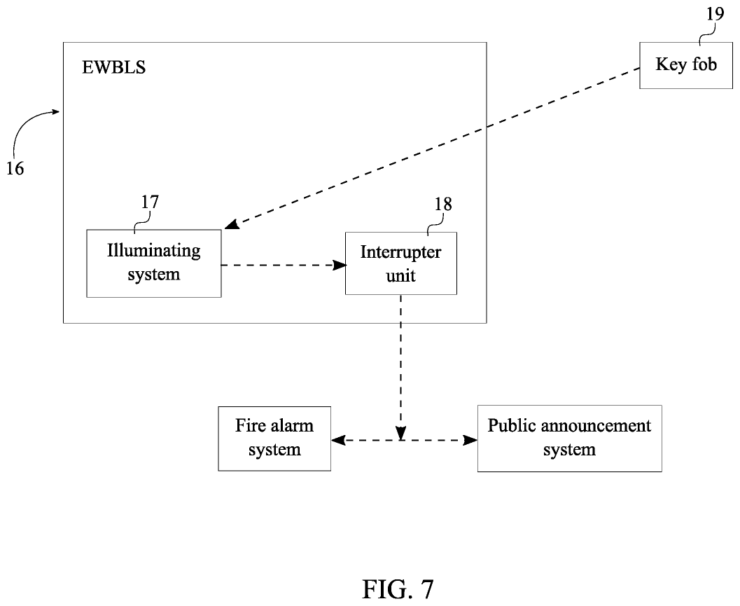

In reference to FIG. 7, the EWBLS 16 comprises an illuminating system 17 and an interrupter unit 18. The illuminating system 17 is a blue light system so that an individual can be alerted about possible or ongoing active shooter incidents. The key fob 19 is remote activation device for the illuminating system 17 so that an individual can activate the illumination system from any remote location. In order to accomplish these tasks, the illuminating system 17 and the key fob 19 are communicably coupled with each other. The interrupter unit 18 is an electronic device that enables two warning systems such as a fire alarm system and a public announcement system to properly functions without contradicting each other. More specifically, the interrupter unit 18 is communicably coupled with the illuminating system 17 and operatively integrated into a fire alarm system of the building 20 and a public announcement system of the building 20, wherein the interrupter unit 18 is selectively used a continuous operation of the fire alarm system and the public announcement system. For example, when illuminating system 17 is activated, the interrupter unit 18 is also activated within the present invention. Considering that the fire alarm system is also activated, the interrupter unit 18 is then able to temporarily mute the fire alarm system during an announcement that may broadcast through the public announcement system so that the announcement can be clearly broadcasted. The interrupter unit 18 does not affect the normal operation of the fire alarm system when the EWBLS 16 is inactive. The EWBLS 16 can also be enhanced with a well-designed video surveillance system to provide added security within the present invention.

Although the invention has been explained in relation to its preferred embodiment, it is to be understood that many other possible modifications and variations can be made without departing from the spirit and scope of the invention as hereinafter claimed.

What is claimed is:

1. A system for protecting and alerting individuals in indoor environments of active shooter incidents comprising:
a foldable shield wall;
a bulletproof door panel;
a foot bolt;
an early warning blue light system (EWBLS);
at least one key fob;
the foldable shield wall, the bulletproof door panel, and the foot bolt being mounted adjacent to each other;
the foldable shield wall being mounted to a structural wall of a room, wherein the room is within a building;
the bulletproof door panel being mounted onto a main entry door of the room;
the foot bolt being mounted onto the main entry door; and
the at least one key fob being communicably coupled with the EWBLS.

2. The system for protecting and alerting individuals in indoor environments of active shooter incidents as claimed in claim 1 comprising:
the foldable shield wall comprises a first bulletproof wall, a second bulletproof wall, a wall attachment, a connector hinge, and a handle;
the first bulletproof wall and the second bulletproof wall being hingedly mounted to each other through the connector hinge;
the wall attachment being terminally mounted to the first bulletproof wall, opposite of the connector hinge; and
the handle being terminally mounted to the second bulletproof wall, opposite of the connector hinge.

3. The system for protecting and alerting individuals in indoor environments of active shooter incidents as claimed in claim 2, wherein the wall attachment being mounted in between the structural wall and the first bulletproof wall.

4. The system for protecting and alerting individuals in indoor environments of active shooter incidents as claimed in claim 2 comprising:
a plurality of caster wheels;
the plurality of caster wheels being mounted to a bottom edge of the first bulletproof wall and the second bulletproof wall; and
the plurality of caster wheels being equally distributed along the bottom edge of the first bulletproof wall and the second bulletproof wall.

5. The system for protecting and alerting individuals in indoor environments of active shooter incidents as claimed in claim 1, wherein the bulletproof door panel being mounted onto an inside panel of the main entry door.

6. The system for protecting and alerting individuals in indoor environments of active shooter incidents as claimed in claim 1 comprising:
the foot bolt comprises a housing and a bolt assembly; and
the bolt assembly being mechanically coupled within the housing, wherein the bolt assembly is configured in between a locked position and an unlocked position.

7. The system for protecting and alerting individuals in indoor environments of active shooter incidents as claimed in claim 6 comprising:
the bolt assembly comprises a deadbolt, an operating mechanism, and a strike plate;
the deadbolt being slidably engaged within the housing;
the operating mechanism being integrated into the deadbolt and the housing;
the strike plate being mounted adjacent to the deadbolt; and
the strike plate being concentrically aligned with the deadbolt.

8. The system for protecting and alerting individuals in indoor environments of active shooter incidents as claimed in claim 1 comprising:
the EWBLS comprises an illuminating system and an interrupter unit;
the illuminating system and the key fob being communicably coupled with each other;
the interrupter unit being communicably coupled with the illuminating system; and
the interrupter unit operatively integrated into a fire alarm system of the building and a public announcement system of the building, wherein the interrupter unit is selectively used a continuous operation of the fire alarm system and the public announcement system.
